(19) United States
(12) Patent Application Publication
(10) Pub. No.: US 2015/0149960 A1
(43) Pub. Date: May 28, 2015

(54) METHOD OF GENERATING PANORAMA IMAGE, COMPUTER-READABLE STORAGE MEDIUM HAVING RECORDED THEREON THE METHOD, AND PANORAMA IMAGE GENERATING DEVICE

(71) Applicant: SAMSUNG ELECTRONICS CO., LTD., Suwon-si (KR)

(72) Inventors: Won-seok Song, Seoul (KR); Myung-kyu Choi, Yongin-si (KR)

(21) Appl. No.: 14/496,176

(22) Filed: Sep. 25, 2014

(30) Foreign Application Priority Data
Nov. 22, 2013 (KR) 10-2013-0143250

(51) Int. Cl. G06F 3/0484; G06F 3/0482

(52) U.S. Cl. CPC G06F 3/04845; G06F 3/0482
USPC 715/810

(57) ABSTRACT

A method of generating a panorama image is described. A plurality of captured images are stored. Motion of a target object is detected from the plurality of captured images and motion information is obtained as a result of the detecting. A plurality of selection images are determined from the plurality of captured images, based on the motion information about the target object. A plurality of composition areas are set in the plurality of selection images, based on a user input. A panorama image is generated, based on images included in the plurality of composition areas.

### CROSS-REFERENCE TO RELATED PATENT APPLICATIONS

This application claims the priority benefit of Korean Patent Application No. 10-2013-0143250, filed on Nov. 22, 2013, in the Korean Intellectual Property Office, the disclosure of which is incorporated by reference herein in its entirety.

### BACKGROUND

1. Field

One or more embodiments of the present disclosure relate to a method of generating a panorama image, a computer-readable storage medium having recorded thereon the method, and a digital image processing device.

2. Related Art

A panorama image is generated in a manner that a series of images captured in different directions are appropriately connected. Compared to an image captured in one direction, the panorama image provides a wider Field Of View (FOV) of a scene around a capturer (e.g., a user of a digital camera), so that a viewer may watch a more realistic captured image.

However, a method of generating a panorama image by using continuous image-capturing according to the related art has a problem in a temporal interval in the continuous image-capturing, and a spatial problem with respect to a composition area.

### SUMMARY

One or more embodiments of the present disclosure include a method of generating a panorama image by setting, according to a user's input, selection images and composition areas from a plurality of captured images for generating the panorama image, so that various panorama image may be generated based on the generated panorama image, according to the user's input.

Additional embodiments will be set forth in part in the description which follows and, in part, will be apparent from the description, or may be learned by practice of the presented embodiments.

According to an embodiment, a method of generating a panorama image includes operations of storing a plurality of captured images; detecting motion of a target object from the plurality of captured images and obtaining motion information as a result of the detecting; determining a plurality of selection images from the plurality of captured images, based on the motion information about the target object; setting a plurality of composition areas in the plurality of selection images, based on a user input; and generating a panorama image, based on images included in the plurality of composition areas.

The motion information may be calculated according to the motion of the target object by comparing a previous frame and a current frame of the plurality of captured images, and the operation of determining the plurality of selection images may include an operation of determining only the current frame as a selection image, wherein the current frame is determined to include the motion of the target object, as a result of the comparing.

The operation of determining the plurality of selection images may include operations of displaying the plurality of captured images that are selectable by a user, on a display unit; and determining the plurality of selection images, based on the plurality of captured images that are selected by the user.

The plurality of composition areas may correspond to same positions in the plurality of selection images.

The plurality of composition areas may include a same target object in the plurality of selection images.

The plurality of composition areas can be set as a plurality of areas in one selection image, based on the user input.

The operation of generating the panorama image may include an operation of generating the panorama image in association with additional information related to the images included in the plurality of composition areas.

The method may further include operations of modifying the plurality of composition areas and, as a result of the modifying, generating a new panorama image from the panorama image, based on a user input.

The operation of generating the panorama image may further include an operation of displaying, on a display unit, the plurality of selection images including the plurality of composition areas that are selected in the panorama image by a user.

According to another embodiment, a panorama image generating device includes an image storage unit for storing a plurality of captured images; a motion detection unit for detecting motion of a target object from the plurality of captured images and obtaining motion information as a result of the detecting; an image selecting unit for determining a plurality of selection images from the plurality of captured images, based on the motion information about the target object; an area selecting unit for setting a plurality of composition areas in the plurality of selection images, based on a user input; an image composing unit for generating a panorama image, based on images included in the plurality of composition areas; a user input unit for receiving a signal related to the plurality of captured images, the plurality of selection images, or the plurality of composition areas; and a control unit for managing information about the plurality of captured images, the plurality of selection images, the plurality of composition areas, or the panorama image, based on the signal that is received by the user input unit.

The motion information may be calculated according to the motion of the target object by comparing a previous frame and a current frame of the plurality of captured images, and the control unit may control the image selecting unit to determine only the current frame as a selection image based on the motion information obtained by the motion detection unit, wherein the current frame is determined to include the motion of the target object.

The control unit may control the plurality of captured images, which are selectable by a user, to be displayed on a display unit, the user input unit may receive a signal for determining the plurality of selection images from the plurality of captured images, and the control unit may control the image selecting unit to determine the plurality of selection images, based on the plurality of captured images that are selected by the user.

The user input unit may receive a signal for setting the plurality of composition areas, and the control unit may control the area selecting unit to set areas, which correspond to same positions in the plurality of selection images, as the plurality of composition areas.

The user input unit may receive a signal for setting the plurality of composition areas, and the control unit may control the area selecting unit to set areas, which include a same target object in the plurality of selection images, as the plurality of composition areas.

The user input unit may receive a signal for setting the plurality of composition areas, and the control unit may control the area selecting unit to set a plurality of areas in one selection image, as the plurality of composition areas.

The control unit may control the image composing unit to generate the panorama image in association with additional information related to the images included in the plurality of composition areas.

The user input unit may receive a signal for modifying the panorama image, and the control unit may control the area selecting unit to modify the plurality of composition areas, based on the signal for modifying the panorama image, and the control unit may control the image composing unit to generate a new panorama image based on the plurality of modified composition areas.

The user input unit may receive a signal for displaying the plurality of selection images, and the control unit may control the plurality of selection images to be displayed on a display unit, wherein the plurality of selection images include the plurality of composition areas that are selected in the panorama image by a user.

According to yet another embodiment, there is provided a non-transitory computer-readable storage medium storing computer program codes for executing a method of generating a panorama image, when the non-transitory computer-readable storage medium is read and the computer program codes executed by a processor, the method including operations of storing a plurality of captured images; detecting motion of a target object from the plurality of captured images and obtaining motion information as a result of the detecting; determining a plurality of selection images from the plurality of captured images, based on the motion information about the target object; setting a plurality of composition areas in the plurality of selection images, based on a user input; and generating a panorama image, based on images included in the plurality of composition areas.

The method may further include an operation of modifying the plurality of composition areas and, as a result of the modifying, generating a new panorama image from the panorama image, based on a user input.

### BRIEF DESCRIPTION OF THE DRAWINGS

These and/or other embodiments will become apparent and more readily appreciated from the following description of various embodiments, taken in conjunction with the accompanying drawings in which:

FIG. 1 is a block diagram of a panorama image generating device for generating a panorama image based on motion of a target object, and managing the panorama image, according to an embodiment;

FIG. 2 is a flowchart of a method of generating a panorama image according to motion of a target object, according to an embodiment;

FIG. 3 is a diagram illustrating an example in which a plurality of selection images are determined by the panorama image generating device, according to an embodiment;

FIG. 4 is a diagram illustrating various examples of selection images and composition areas in the panorama image generating device, according to an embodiment;

FIG. 5 is a diagram illustrating various panorama images that are generated based on images included in composition areas, by the panorama image generating device, according to an embodiment;

FIG. 6 is a flowchart of a method of modifying a generated panorama image, according to an embodiment;

FIG. 7 and FIG. 8 are diagrams illustrating various examples in which the panorama image generating device modifies composition areas and thus generates new panorama images, according to embodiments;

FIG. 9 is a diagram illustrating an example in which the panorama image generating device displays a panorama image including composition areas on a display unit, based on a user input, according to an embodiment; and

FIG. 10 is a diagram illustrating a structure of an image file, according to an embodiment.

### DETAILED DESCRIPTION

Various embodiments of the present disclosure will now be described more fully with reference to the accompanying drawings, in which exemplary embodiments of the invention are shown. The invention may, however, be embodied in many different forms, and should not be construed as being limited to the embodiments set forth herein. Thus, the invention may include all revisions, equivalents, or substitutions which are included in the concept and the technical scope related to the invention.

While terms “first” and “second” are used to describe various components, it is obvious that the components are not limited to the terms “first” and “second”. The terms “first” and “second” are used only to distinguish between each component.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

Reference will now be made in detail to embodiments, examples of which are illustrated in the accompanying drawings, wherein like reference numerals refer to like elements throughout. Those elements that are the same or are in correspondence are rendered the same reference numeral regardless of the figure number, and redundant explanations are omitted.

As used herein, the term “and/or” includes any and all combinations of one or more of the associated listed items. Expressions such as “at least one of,” when preceding a list of elements, modify the entire list of elements and do not modify the individual elements of the list.

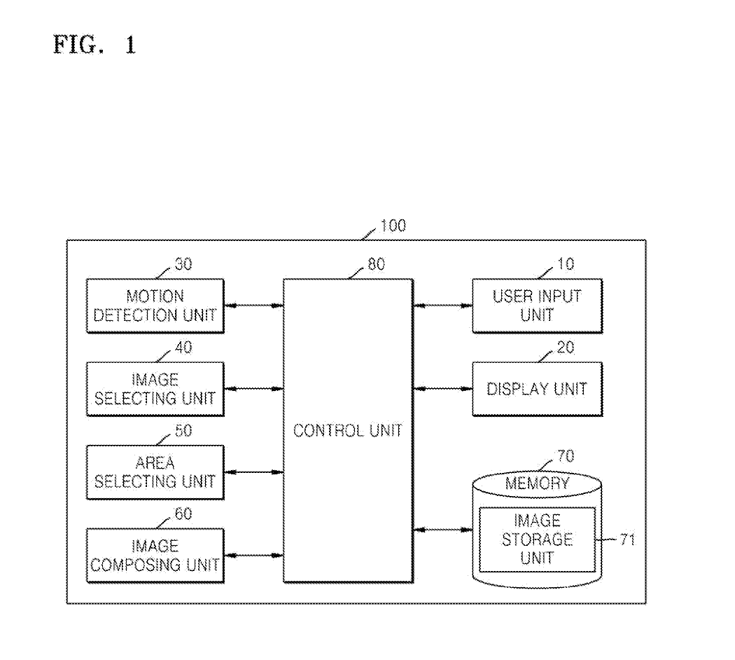

FIG. 1 is a block diagram of a panorama image generating device 100 for generating a panorama image based on motion of a target object, and managing the panorama image, according to an embodiment.

As illustrated in FIG. 1, the panorama image generating device 100 may include a user input unit 10, a display unit 20, a motion detection unit 30, an image selecting unit 40, an area selecting unit 50, an image composing unit 60, a memory 70, an image storage unit 71, and a control unit 80.

Hereinafter, the aforementioned elements are described below.

The panorama image generating device 100 may include various devices such as a digital camera, a mobile phone, a smart phone, a laptop computer, a tablet personal computer (PC), an electronic book terminal, a terminal for digital broadcasting, a personal digital assistant (PDA), a portable multimedia player (PMP), or the like that are enabled to store, manage, and reproduce digital images.

In the present embodiment, operations by the panorama image generating device 100 are controlled by the control unit 80. Also, the panorama image generating device 100 includes the user input unit 10 including one or more keys, buttons, or the like that generate an electrical signal for a user based on the user's input. The electrical signal generated by the user input unit 10 is transferred to the control unit 80, so that the control unit 80 may control the panorama image generating device 100 according to the electrical signal (e.g., based on the user's input).

The user input unit 10 may generate input data for controlling an operation by the panorama image generating device 100. The user input unit 10 may include a key pad, a dome switch, a touch pad (a touch capacitive type touch pad, a pressure resistive type touch pad, an infrared beam sensing type touch pad, a surface acoustic wave type touch pad, an integral strain gauge type touch pad, a piezoelectric effect type touch pad, or the like), a jog wheel, a jog switch, etc. In particular, when the touch pad and the display unit 20 (described below) form a mutual layer structure, this structure may be called a touch screen.

In this case, the user input unit 10 may sense a user's touch gesture on a touch screen by using a touch screen module (not shown) or software component stored in the memory 70, and may transfer information about the touch gesture to the control unit 80. The touch screen module may be configured as a separate controller in the form of hardware.

The user input unit 10 may receive a signal related to a plurality of captured images, a plurality of selection images, or a plurality of composition areas, which may be used in generating a panorama image.

In the present embodiment, information about the captured images, the selection images, or the composition areas may be stored in the image storage unit 71.

Also, the user input unit 10 may receive an input of a signal for determining selection images from the captured images.

Also, the user input unit 10 may receive an input of a signal for setting composition areas in the selection images.

Also, the user input unit 10 may receive an input of a signal for modifying the generated panorama image.

Also, the user input unit 10 may receive an input of a signal for displaying a selection image, by using the generated panorama image.

For example, the signal related to the captured images, the selection images, or the composition areas, which is used in generating the panorama image, may be generated based on a user's touch gesture that is input to the user input unit 10. For example, the user's touch gesture may include a tap gesture, a touch & hold gesture, a double tap gesture, a drag gesture, a panning gesture, a flick gesture, a drag & drop gesture, a swipe gesture, or the like.

The display unit 20 may include at least one of a liquid crystal display (LCD), a thin film transistor-liquid crystal display (TFT-LCD), an organic light-emitting diode display, a flexible display, or a three-dimensional (3D) display.

When the display unit 20 and the touch pad form a mutual layer structure and then are formed as a touch screen, the display unit 20 may be used as both an output device and an input device. The touch screen may be formed to sense a position of a touch input, a touched area, and a touch input pressure. Also, the touch screen may detect not only an actual touch but also may detect a proximity-touch.

In the present embodiment, the display unit 20 may display a captured image stored in the image storage unit 71. When the captured images are displayed, thumbnail images of the captured images, which are selectable by a user, may be displayed on the display unit 20.

The motion detection unit 30 may detect motion of a target object in the captured images stored in the image storage unit 71, and thus may obtain motion information.

In the present embodiment, the captured images may be captured during a continuous image-capturing mode.

The motion information about the target object may be calculated according to the motion of the target object by comparing a previous frame and a current frame of the captured images.

For example, after hand-shaking that is generated by movement of the panorama image generating device 100 is removed by detecting a global motion, the motion of the target object between frames is calculated by detecting a local motion.

However, a method of detecting the motion of the target object between the frames of the captured images is not limited to the aforementioned manner, and includes other various methods such as a learning method, or the like that are well-known in the art. Thus, it is recommended to note that the method of detecting the motion of the target object is not limited to a specific method.

The image selecting unit 40 may determine selection images from the captured images, based on the motion information about the target object which is obtained by the motion detection unit 30.

In the present embodiment, the selection images may include a plurality of frame images that are used in generating the panorama image.

For example, the selection image may include only a current frame that is determined to include the motion of the target object, compared to a previous frame.

In this case, another current frame that is determined not to include the motion of the target object, compared to the previous frame, may not be used in generating the panorama image.

However, in the present embodiment, if the image selecting unit 40 does not consider the motion of the target object, all of the captured images may be determined as the selection images.

Also, the selection images may be determined from the captured images displayed on the display unit 20, in response to a user input.

For example, when a user selects a start image and an end image from the captured images, images that are captured between a captured time of the start image and a captured time of the end image may be determined as selection areas.

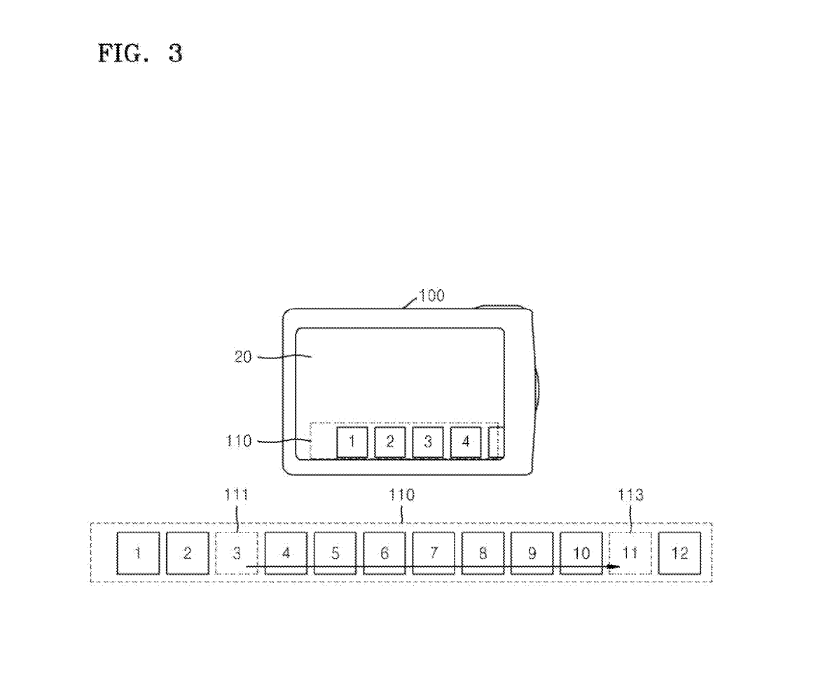

This will be described in detail with reference to FIG. 3.

In the present embodiment, the area selecting unit 50 may set a plurality of composition areas in the selection images that are determined by the image selecting unit 40.

For example, the composition areas may correspond to same positions in the selection images.

Alternatively, the composition areas may indicate areas that include the same target object in the selection images.

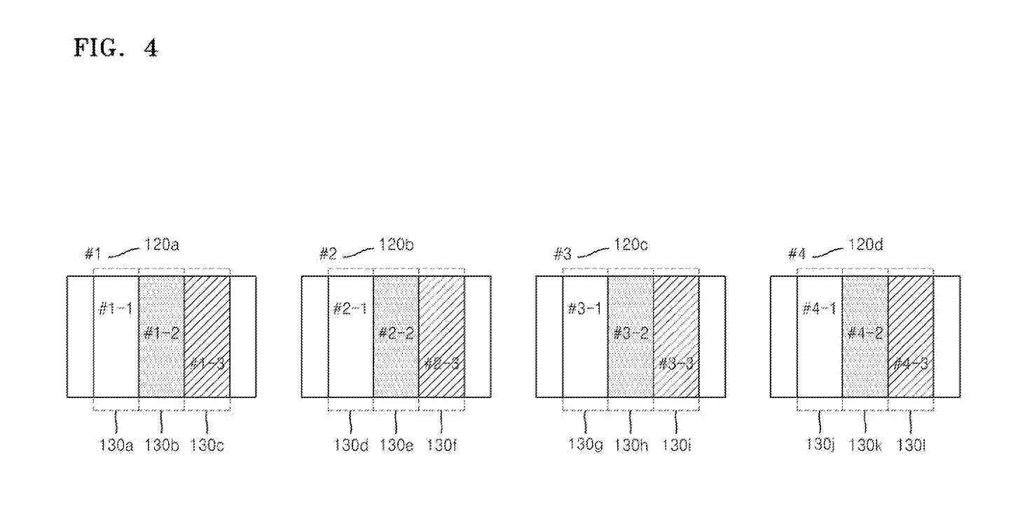

Alternatively, the composition areas may be set as a plurality of areas in one selection image, based on a user input. This will be described in detail with reference to FIG. 4.

Accordingly, since the area selecting unit 50 may set various composition areas from the selection images according to a user's input, various panorama images may be generated.

The image composing unit 60 may generate the panorama image, based on images included in the composition areas that are set by the area selecting unit 50.

The panorama image may be generated in association with additional information related to the images included in the composition areas. For example, the panorama image may be generated by using not only image information included in the composition area but also by using additional information such as audio information, etc.

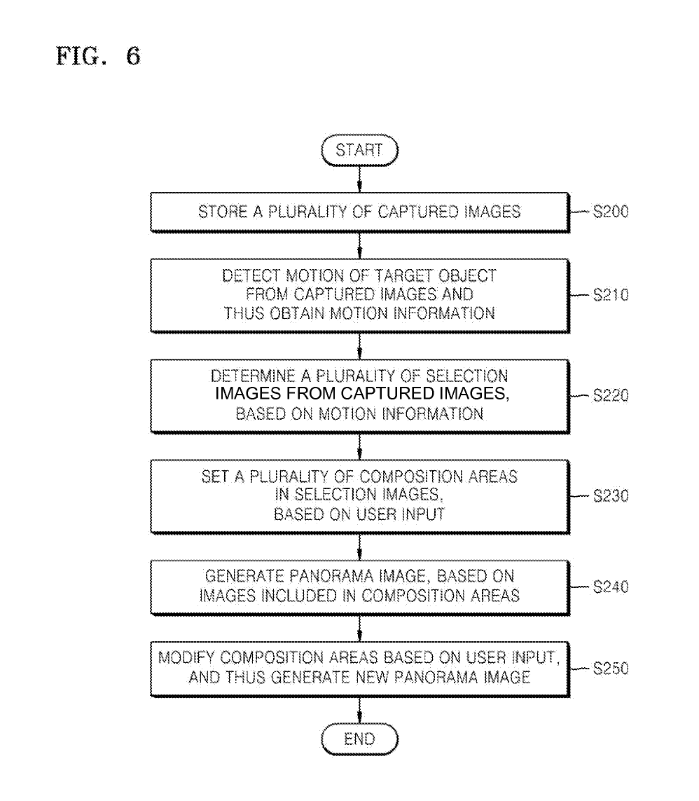

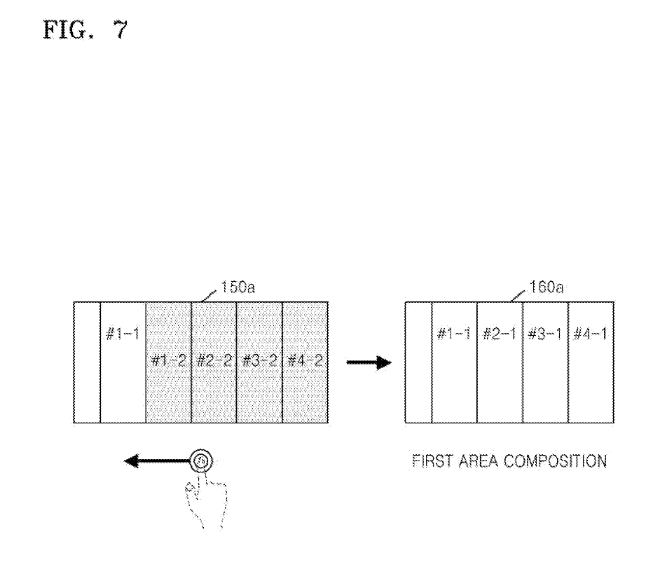

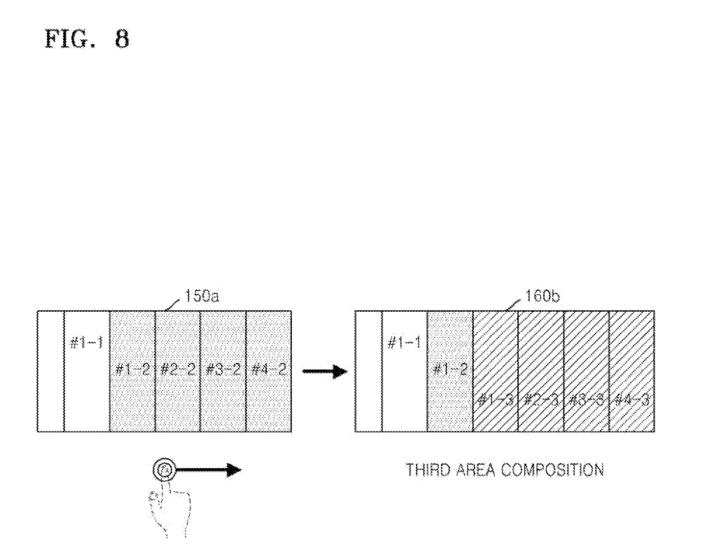

Also, the panorama image may be modified, based on a user input. For example, the composition areas may be modified so that a new panorama image may be generated. This will be described in detail with reference to FIG. 6, FIG. 7, and FIG. 8.

The panorama image may be used to display originals of the selection images including the composition areas, on the display unit 20.

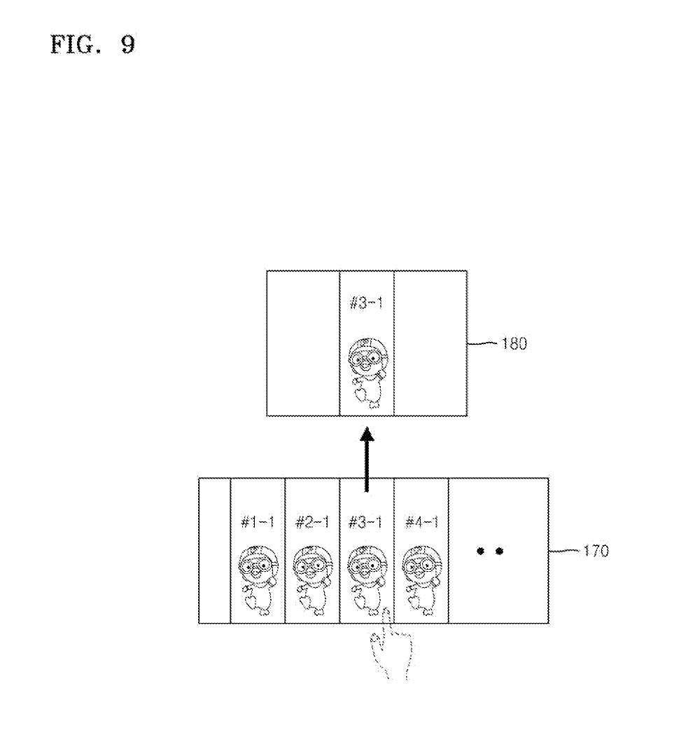

This will be described in detail with reference to FIG. 9.

Accordingly, since the image composing unit 60 may reset the composition areas in the panorama images, according to a user's input, various panorama images may be generated.

The memory 70 may store one or more images obtained by the panorama image generating device 100. Also, the memory 70 may store one or more panorama image files generated by the image composing unit 60.

The memory 70 may store one or more programs for processing and controlling operations by the control unit 80, and may store input or output data.

The memory 70 may include at least one storage medium, such as a flash memory-type storage medium, a hard disk-type storage medium, a multimedia card micro-type storage medium, card-type memories (e.g., an SD card, an XD memory, and the like), Random Access Memory (RAM), Static Random Access Memory (SRAM), Read-Only Memory (ROM), Electrically Erasable Programmable Read-Only Memory (EEPROM), Programmable Read-Only Memory (PROM) magnetic memory, a magnetic disc, or an optical disc.

The programs stored in the memory 70 may be divided into a plurality of modules according to their functions. For example, the programs may be divided into a user interface (UI) module (not shown), a touch screen module (not shown), or the like.

The UI module may provide a UI, a graphical user interface (GUI), or the like that interoperate with the panorama image generating device 100. The function of the UI module may be intuitionally deduced by one of ordinary skill in the art by referring to a name of the UI module, thus, detailed descriptions thereof are omitted here.

The touch screen module may sense a user's touch gesture on the touch screen, and may transfer information about the touch gesture to the control unit 80. The touch screen module may be configured as a separate controller in the form of hardware.

For example, the user's touch gesture may include a tap gesture, a touch & hold gesture, a double tap gesture, a drag gesture, a panning gesture, a flick gesture, a drag & drop gesture, a swipe gesture, or the like.

The image storage unit 71 may store the captured images.

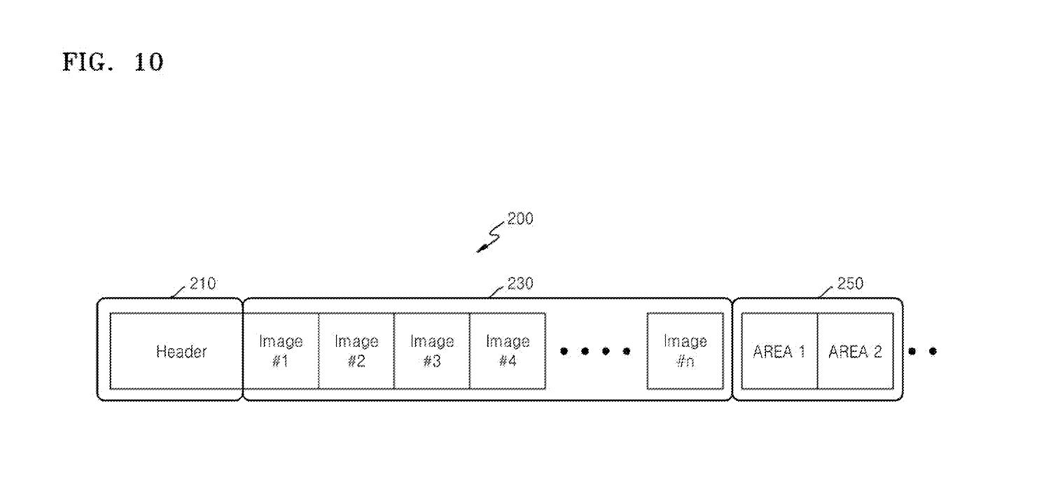

The image storage unit 71 may store an image file including information about the captured images, the selection images, the composition areas, or the panorama image. A structure of the image file will be described in detail with reference to FIG. 10.

Various operations of the panorama image generating device 100 are controlled by the control unit 80. That is, the control unit 80 may execute the programs stored in the memory 70 and thus may control the user input unit 10, the display unit 20, the motion detection unit 30, the image selecting unit 40, the area selecting unit 50, the image composing unit 60, the memory 70, the image storage unit 71, etc.

The control unit 80 may manage the information about the captured images, the selection images, the composition areas, or the panorama image, based on a signal received from the user input unit 10.

For example, in the present embodiment, the control unit 80 may control the image selecting unit 40 to compare a previous frame and a current frame and then to determine the current frame as a selection image only when the current frame includes motion of the target object, based on the motion information obtained by the motion detection unit 30.

Also, the control unit 80 may control the captured images, which are selectable by the user, to be displayed on the display unit 20.

Here, the user input unit 10 may receive an input of a signal for determining selection images. In this case, in response to the signal that is input to the user input unit 10, the control unit 80 may control the image selecting unit 40 to determine the selection images based on the captured images selected by the user.

The control unit 80, in response to a signal that is input to the user input unit 10 so as to set composition areas, may control the area selecting unit 50 to set the composition areas that correspond to same positions in the selection images.

Also, the control unit 80, in response to a signal that is input to the user input unit 10 so as to set composition areas, may control the area selecting unit 50 to set the composition areas that include the same target object in the selection images.

Also, the control unit 80, in response to a signal that is input to the user input unit 10 so as to set composition areas, may control the area selecting unit 50 to set the composition areas that are a plurality of areas in one selection image.

Also, the control unit 80, in response to a signal that is input to the user input unit 10 so as to modify the panorama image, may control the area selecting unit 50 to modify the composition areas and may control the image composing unit 60 to generate a new panorama image based on the modified composition areas.

Various operations of the panorama image generating device 100 will now be described.

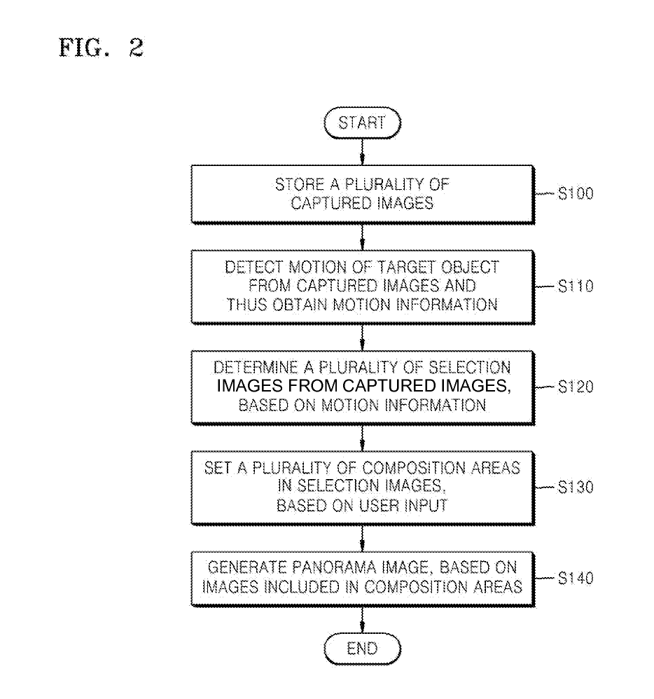

FIG. 2 is a flowchart of a method of generating a panorama image according to motion of a target object, according to an embodiment.

In operation S100, the panorama image generating device 100 stores a plurality of captured images.

For example, the captured images may be captured during a continuous image-capturing mode.

In operation S110, the panorama image generating device 100 detects motion of a target object from the captured images stored in operation S100, and thus obtains motion information.

The motion information about the target object may be calculated according to the motion of the target object by comparing a previous frame and a current frame of the captured images.

For example, after hand-shaking that is generated during movement of the panorama image generating device 100 (e.g., movement to capture the images) is removed by detecting a global motion, the motion of the target object between frames is calculated by detecting a local motion.

However, a method of detecting the motion of the target object between the frames of the captured images is not limited to the aforementioned manner, and includes other various methods such as a learning method, or the like that are well- known in the art. Thus, it is noted that the method of detecting the motion of the target object is not limited to a specific method.

In operation S120, the panorama image generating device 100 determines a plurality of selection images from the captured images, based on the motion information that is obtained in operation S110.

In the present embodiment, the selection images may include a plurality of frame images that are used in generating the panorama image.

For example, the selection image may include only a current frame that is determined to include the motion of the target object, compared to a previous frame.

In this case, another current frame that is determined not to include the motion of the target object, compared to the previous frame, may not be used in generating the panorama image.

However, in the present embodiment, if the image selecting unit 40 does not consider the motion of the target object (e.g., if the motion information does not indicate motion of an object), all of the captured images may be determined as the selection images.

Also, the selection images may be determined from the captured images displayed on the display unit 20, in response to a user input.

For example, when a user selects a start image and an end image from the captured images, images that are captured between a captured time of the start image and a captured time of the end image may be determined as selection areas.

This will be described in detail with reference to FIG. 3.

According to the method of generating the panorama image, selection images may be selected from the captured images without a temporal limit during the continuous image-capturing mode according to the motion of the target object or a user's input, so that various panorama images may be generated.

In operation S130, the panorama image generating device 100 sets a plurality of composition areas in the selection images that are determined in operation S120.

For example, the composition areas may correspond to same positions in the selection images.

Alternatively, the composition areas may indicate areas that include the same target object in the selection images.

Alternatively, the composition areas may be set as a plurality of areas in one selection image, based on a user input. This will be described in detail with reference to FIG. 4.

According to the method of generating the panorama image, various composition areas are set from the selection images according to a user's input, so that various panorama images may be generated.

In operation S140, the panorama image generating device 100 generates a panorama image, based on images (or image portions) included in the composition areas that are set in operation S130.

The panorama image may be generated in association with additional information related to images that are included in the composition areas. For example, the panorama image may be generated by using not only image information included in the composition area but also by using additional information such as audio information, etc.

Also, the panorama image may be modified, based on a user input. For example, the composition areas may be modified so that a new panorama image may be generated. This will be described in detail with reference to FIG. 6, FIG. 7, and FIG. 8.

FIG. 3 illustrates an example in which a plurality of selection images are determined by the panorama image generating device 100, according to an embodiment.

For example, as illustrated in FIG. 3, 12 thumbnail images (labeled as 1, 2, 3, . . . 12) that correspond to captured images 110 stored in the memory 70 may be displayed on the display unit 20 of the panorama image generating device 100.

A user may select a start image 111 and an end image 113 from the captured images 110 that are displayed on the display unit 20, wherein composition of a panorama image is performed between the start image 111 and the end image 113.

For example, as illustrated in FIG. 3, the user may select a third thumbnail image as the start image 111, and may select an eleventh thumbnail image as the end image 113.

In this case, only the captured images between a captured image corresponding to the user-selected third thumbnail image and a captured image corresponding to the user-selected eleventh thumbnail image may be determined as selection images to be used in generating the panorama image.

Accordingly, the panorama image generating device 100 may determine various selection images from the captured images, according to a user's input, and thus may generate various panorama images.

However, when the user does not select the start image 111 and the end image 113 from the captured images 110 that are displayed on the display unit 20, wherein the composition of the panorama image is performed therebetween, all of the captured images 110 that are displayed on the display unit 20 may be determined as selection images.

FIG. 4 illustrates examples of selection images 120a, 120b, 120c, and 120d and composition areas 130a, 130b, 130c, 130d, 130e, 130f, 130g, 130h, 130i, 130j, 130k, and 130l in the panorama image generating device 100, according to an embodiment.

For example, as illustrated in FIG. 4, the selection images 120a through 120d and the composition areas 130a through 130l may be set to be used in generating a panorama image.

For example, composition areas may correspond to same positions in selection images. Alternatively, the composition areas may indicate areas that include the same target object in the selection images. Alternatively, the composition areas may be set as a plurality of areas in one selection image, based on a user input.

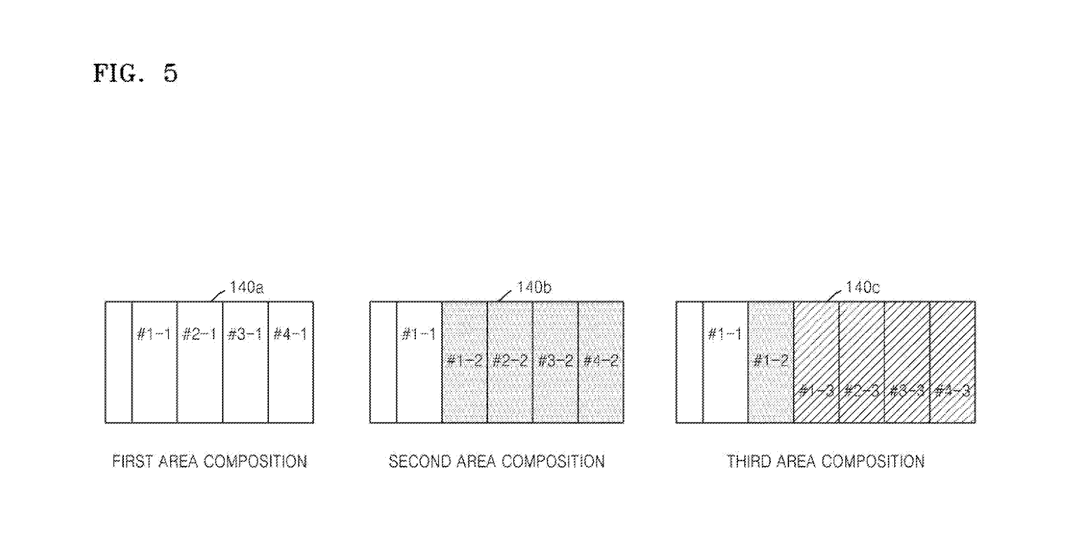

FIG. 5 illustrates various panorama images that are generated based on images included in composition areas, by the panorama image generating device 100, according to an embodiment.

For example, in the examples of FIG. 4, when the composition areas 130a, 130d, 130g, and 130j that correspond to same positions in the selection images 120a through 120d are set as composition areas, as illustrated in FIG. 5, a first panorama image 140a may be generated.

Also, the composition areas 130a and 130b in the selection image 120a of FIG. 4 may be set as composition areas, and the composition areas 130e, 130h, and 130k in the selection images 120b through 120d which are at the same positions as a position of the composition area 130b may be set as composition areas. In this case, as illustrated in FIG. 5, a second panorama image 140b may be generated.

Also, the composition areas 130a through 130c in the selection image 120a of FIG. 4 may be set as composition areas, and the composition areas 130f, 130i, and 130l in the selection images 120b through 120d which are at the same positions as a position of the composition area 130c may be set as composition areas. In this case, as illustrated in FIG. 5, a panorama image 140c may be generated.

As described above, the panorama image generating device 100 may set various composition areas from selection images, according to a user's input, and thus may generate various panorama images.

Hereinafter, operations by the panorama image generating device 100 will be described.

FIG. 6 is a flowchart of a method of modifying a generated panorama image, according to an embodiment.

Since operations 200, 210, 220, 230, and 240 correspond to operations 100, 110, 120, 130, and 140 in FIG. 1, respectively, detailed descriptions are omitted here.

In operation S250, the panorama image generating device 100 may modify composition areas in the panorama image generated in operation S240, based on a user input, and thus generates a new panorama image. This will be described in detail with reference to FIG. 7 and FIG. 8.

FIG. 7 and FIG. 8 illustrate examples in which the panorama image generating device 100 modifies composition areas and thus generates new panorama images, according to various embodiments.

As illustrated in FIG. 7 and FIG. 8, a signal may be input so as to modify a panorama image 150a, based on a user input.

The signal for modifying the panorama image 150a may be generated in response to a user's touch gesture that is input to the user input unit 10. For example, the user's touch gesture may include a tap gesture, a touch & hold gesture, a double tap gesture, a drag gesture, a panning gesture, a flick gesture, a drag & drop gesture, a swipe gesture, or the like.

In this case, according to the signal for modifying the panorama image 150a, composition areas to be used in re-generating a panorama image may be modified.

For example, as illustrated in FIG. 7, when a user's touch gesture is input in a left direction on the panorama image 150a on a display unit, or as illustrated in FIG. 8, when a user's touch gesture is input in a right direction on the panorama image 150a on a display unit, new panorama images 160a and 160b with modified composition areas may be generated.

As described above, according to the method of generating a panorama image, composition areas may be reset based on the generated panorama image, according to a user's input, so that various panorama images may be generated.

FIG. 9 illustrates an example in which the panorama image generating device 100 displays a selection image including a composition area on the display unit 20, based on a user input, according to an embodiment.

In the present embodiment, a user-desired selection image may be displayed on the display unit 20 or may be stored in the memory 70, by using the panorama image 170.

As illustrated in FIG. 9, when a user selects a composition area in the panorama image 170 (e.g., corresponding to image #3-1), an original 180 of a selection image that corresponds to the selected composition area may be displayed on the display unit 20.

FIG. 10 illustrates a structure of an image file 200, according to an embodiment.

The image storage unit 71 of the panorama image generating device 100 may store an image file including information about captured images, selection images, composition areas, or a panorama image.

For example, the captured images that are captured so as to generate the panorama image may be stored in the image storage unit 71 of the panorama image generating device 100. In this case, the image file stored in the image storage unit 71 has a format other than a Joint Photography Experts Group (JPEG) format.

As illustrated in FIG. 10, the structure of the image file 200 may be configured to include a header 210, captured image information 230, and composition information 250.

The header 210 may include information about the captured images, the selection images, the composition areas, or the panorama image.

For example, the header 210 may include, but is not limited to, basic information about the captured images, information provided from the motion detection unit 30, information provided from the area selecting unit 50, information provided from the image composing unit 60, or the like.

The basic information about the captured images may include a version of each of the captured images, the number of the captured images, a size (i.e., a width and height) of each of the captured images, a time interval between frames, etc.

The information provided from the motion detection unit 30 may include information about motion between sequential frames of each of the captured images.

The information provided from the area selecting unit 50 may include information (e.g., an x coordinate, a y coordinate, a width, a height, etc.) about a set composition area, or the like.

The information provided from the image composing unit 60 may include information about a relation between a composed portion of a composed image and an original image, or the like.

The captured image information 230 may include visual information or audio information about the captured images that are captured by a user during a continuous image-capturing mode so as to generate the panorama image.

The composition information 250 may include information for expressing the composition areas, which are used in generating the panorama image, as a mask, or information about the panorama image.

A plurality of pieces of the information included in the structure of the image file 200 may be modified by the user. For example, various modifications may be applied to the captured images, the selection images, or the composition areas that are used in generating the panorama image.

As described above, according to the method of generating the panorama image, selection images may be selected from the captured images without a temporal limit during the continuous image-capturing mode according to the motion of the target object or a user's input, so that various panorama images may be generated.

Also, according to the method of generating the panorama image, various composition areas are set from the selection images according to a user's input, so that various panorama images may be generated.

Also, according to the method of generating the panorama image, composition areas may be reset based on the generated panorama image, according to a user's input, so that various panorama images may be generated.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method of generating a panorama image, the method comprising:
storing a plurality of captured images;
detecting motion of a target object from the plurality of captured images and obtaining motion information as a result of the detecting;
determining a plurality of selection images from the plurality of captured images, based on the motion information about the target object;
setting a plurality of composition areas in the plurality of selection images, based on a user input; and
generating a panorama image, based on images included in the plurality of composition areas.

2. The method of claim 1, wherein the motion information is calculated according to the motion of the target object by comparing a previous frame and a current frame of the plurality of captured images, and
wherein the determining of the plurality of selection images comprises determining only the current frame as a selection image, wherein the current frame is determined to comprise the motion of the target object, as a result of the comparing.

3. The method of claim 1, wherein the determining of the plurality of selection images comprises:
displaying the plurality of captured images that are selectable by a user, on a display unit; and
determining the plurality of selection images, based on the plurality of captured images that are selected by the user.

4. The method of claim 1, wherein the plurality of composition areas correspond to same positions in the plurality of selection images.

5. The method of claim 1, wherein the plurality of composition areas comprise a same target object in the plurality of selection images.

6. The method of claim 1, wherein the plurality of composition areas can be set as a plurality of areas in one selection image, based on the user input.

7. The method of claim 1, wherein the generating of the panorama image comprises generating the panorama image in association with additional information related to the images included in the plurality of composition areas.

8. The method of claim 1, further comprising modifying the plurality of composition areas and, as a result of the modifying, generating a new panorama image from the panorama image, based on a user input.

9. The method of claim 1, wherein the generating of the panorama image further comprises displaying, on a display unit, the plurality of selection images comprising the plurality of composition areas that are selected in the panorama image by a user.

10. A panorama image generating device comprising:
an image storage unit for storing a plurality of captured images;
a motion detection unit for detecting motion of a target object from the plurality of captured images and obtaining motion information as a result of the detecting;
an image selecting unit for determining a plurality of selection images from the plurality of captured images, based on the motion information about the target object;
an area selecting unit for setting a plurality of composition areas in the plurality of selection images, based on a user input;
an image composing unit for generating a panorama image, based on images included in the plurality of composition areas;
a user input unit for receiving a signal related to the plurality of captured images, the plurality of selection images, or the plurality of composition areas; and
a control unit for managing information about the plurality of captured images, the plurality of selection images, the plurality of composition areas, or the panorama image, based on the signal that is received by the user input unit.

11. The panorama image generating device of claim 10, wherein the motion information is calculated according to the motion of the target object by comparing a previous frame and a current frame of the plurality of captured images, and
wherein the control unit controls the image selecting unit to determine only the current frame as a selection image based on the motion information obtained by the motion detection unit, wherein the current frame is determined to comprise the motion of the target object.

12. The panorama image generating device of claim 10, wherein the control unit controls the plurality of captured images, which are selectable by a user, to be displayed on a display unit,
the user input unit receives a signal for determining the plurality of selection images from the plurality of captured images, and
the control unit controls the image selecting unit to determine the plurality of selection images, based on the plurality of captured images that are selected by the user.

13. The panorama image generating device of claim 10, wherein the user input unit receives a signal for setting the plurality of composition areas, and
wherein the control unit controls the area selecting unit to set areas, which correspond to same positions in the plurality of selection images, as the plurality of composition areas.

14. The panorama image generating device of claim 10, wherein the user input unit receives a signal for setting the plurality of composition areas, and
wherein the control unit controls the area selecting unit to set areas, which comprise a same target object in the plurality of selection images, as the plurality of composition areas.

15. The panorama image generating device of claim 10, wherein the user input unit receives a signal for setting the plurality of composition areas, and
wherein the control unit controls the area selecting unit to set a plurality of areas in one selection image, as the plurality of composition areas.

16. The panorama image generating device of claim 10, wherein the control unit controls the image composing unit to generate the panorama image in association with additional information related to the images included in the plurality of composition areas.

17. The panorama image generating device of claim 10, wherein the user input unit receives a signal for modifying the panorama image, and
wherein the control unit controls the area selecting unit to modify the plurality of composition areas, based on the signal for modifying the panorama image, and the control unit controls the image composing unit to generate a new panorama image based on the plurality of modified composition areas.

18. The panorama image generating device of claim 10, wherein the user input unit receives a signal for displaying the plurality of selection images, and
wherein the control unit controls the plurality of selection images to be displayed on a display unit, wherein the plurality of selection images comprise the plurality of composition areas that are selected in the panorama image by a user.

19. A non-transitory computer-readable storage medium storing computer program codes for executing a method of generating a panorama image, when the non-transitory computer-readable storage medium is read and the computer program codes executed by a processor, the method comprising:
storing a plurality of captured images;
detecting motion of a target object from the plurality of captured images and obtaining motion information as a result of the detecting;
determining a plurality of selection images from the plurality of captured images, based on the motion information about the target object;
setting a plurality of composition areas in the plurality of selection images, based on a user input; and
generating a panorama image, based on images included in the plurality of composition areas.

20. The non-transitory computer-readable storage medium of claim 19, wherein the method further comprises modifying the plurality of composition areas and, as a result of the modifying, generating a new panorama image from the panorama image, based on a user input.
